(19) United States
(12) Patent Application Publication
(10) Pub. No.: US 2026/0100309 A1
(43) Pub. Date: Apr. 9, 2026

(54) HIGH TEMPERATURE ELECTRICAL CONDUCTOR INSULATION FOR ELECTROMECHANICAL DEVICES

(71) Applicant: Honeywell International Inc., Charlotte, NC (US)

(72) Inventors: Eric Passman, Piscataway, NJ (US); Mahdi Mohajeri, Morristown, NJ (US)

(73) Assignee: Honeywell International Inc., Charlotte, NC (US)

(21) Appl. No.: 18/908,524

(22) Filed: Oct. 7, 2024

(51) Int. Cl. H01F 41/12; H01F 27/32; H01B 7/29

(52) U.S. Cl. CPC H01F 41/122; H01F 27/323; H01B 7/292

(57) ABSTRACT

A method of forming a bonded coil is disclosed. A flat and/or rectangular wire conductor is formed into a spring. The spring is coated with ingredients using a first heat treatment to remove any organic material from the ingredients that cannot withstand temperatures above a first temperature. The spring is compressed into an edge-wound coil. A second heat treatment is performed at a second temperature to bond the edge-wound coil together and form the bonded coil. The bonded coil can operate in a temperature range up to a melting point of the insulation without degradation.

### BACKGROUND

Conductors (e.g., coils in a motor) in electromechanical devices are often insulated with organic material forming a rubber or plastic sleeve. This may undesirably limit the operating temperature of an electromechanical device (e.g., to 220 degrees Celsius) and for a shorter amount of time.

Accordingly, it may be beneficial to create conductor insulation that can withstand high temperature environments.

### SUMMARY

A method of forming a bonded coil is disclosed. A flat and/or rectangular wire conductor is formed into a spring. The spring is coated with ingredients using a first heat treatment to remove any organic material from the ingredients that cannot withstand temperatures above a first temperature. The spring is compressed into an edge-wound coil. A second heat treatment is performed at a second temperature to bond the edge-wound coil together and form the bonded coil. The bonded coil can operate in a temperature range up to a melting point of the insulation without degradation.

A bonded coil is disclosed. The bonded coil includes a flat and/or rectangular wire conductor formed into a spring. The bonded coil also includes ingredients that coat the spring, wherein a first heat treatment removes any organic material from the ingredients that cannot withstand temperatures above a first temperature and form insulation around the spring. The spring is compressed into an edge-wound coil and a second heat treatment at a second temperature bonds the edge-wound coil together and form the bonded coil. The bonded coil can operate in a temperature range up to a melting point of the insulation without degradation.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1A is a cross-section view of a first example configuration of a flat wire conductor that may be used in the present systems and methods;

FIG. 1B is a cross-section view of a second example configuration of a flat wire conductor that may be used in the present systems and methods;

FIG. 2 is a perspective view of a flat wire conductor formed into a spring in the present systems and methods;

FIG. 3 is a perspective view of a coil that may be formed from a spring in the present systems and methods; and

FIG. 4 is a flow diagram illustrating a method for forming a coil.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

Conductors are used in a variety of electromechanical applications, e.g., a conductor formed into a coil can be used in a motor. Frequently, conductors are insulated with organic materials that may undesirably limit the operating temperature and/or duration of the conductor. However, there is an ongoing demand to use electromagnetic devices at high temperatures (e.g., above 400 degrees Celsius). Most industry-standard organic insulation has a long-term exposure limit below 150 degrees Celsius and a short term exposure limit around 260 degrees Celsius (above which organic insulation materials rapidly decompose, become brittle, and ultimately fail ).

Higher power devices such as propulsion motors, axial flux motors, and generators often make use of flat or ribbon wire conductors specifically customized to conductor cross-section shape and coil shape. The need for high temperature conductor insulation for these types of devices is magnified by the expected high voltages and heat generation that will be required to produce enough output power.

Thus, the present systems and methods uses a high-temperature insulation (HTI) material that can be used on unique conductors in electromechanical devices. This could allow operating higher temperatures (e.g., above 400 degrees Celsius). A conductor capable of operating at such temperatures could reduce cooling needs, decrease weight, and allow increased power/power density.

The high temperature conductor insulation may be applied to a pre-formed coil as a glass powder applied via various formulations (e.g., slurries or pastes) using one or more coating methods, e.g., screen printing, spraying, painting, die, dipping, etc. The coating application method may be chosen based, at least in part, on the shape of the conductor and the shape of the coil. The coil may then be thermally processed to impart high-temperature insulation properties. Depending on the device design, the coil can be pre-installed in the device prior to thermal processing, or it can be installed after thermal curing. Without limitation, one example configuration is a pure copper flat-wire insulated via a spray technique that may demonstrate a voltage breakdown of ~800V/mil (on par with organic materials) after thermal processing.

As described below, the advantages of the present systems and methods include: (1) the insulation coating method is compatible with asymmetric coils (e.g., one side of the coil may have an odd number of edges, while the other side of the coil may have an even number of edges) where conventional methods of applying insulation coating would not work on asymmetric coils; (2) the coating is applied to a flat wire conductor during and/or after the spring and/or coil is shaped which prevents the insulation at the 180 degree turns in the flat wire conductor from ripping apart (and requiring reapplication) if the insulation coating were pre-applied to round wires before shaping as is conventionally done; (3) the bonded coil of the present systems and methods is formed into its final shape using a high-temperature thermal process (in which the adjacent layers of insulation are bonded to each other), while conventionally the final shape of a coil is formed in a winding process.

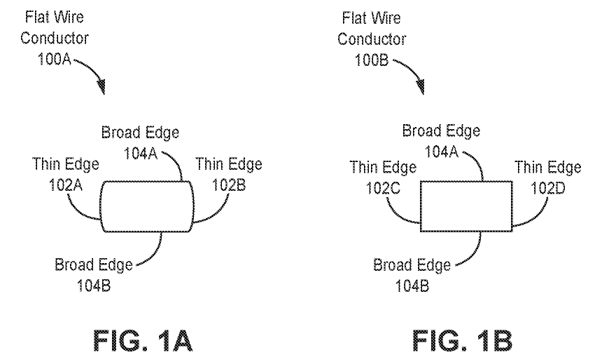

FIG. 1A is a cross-section view of a first example configuration of a flat wire conductor 100A that may be used in the present systems and methods. The cross section of the flat wire conductor 100A may be rectangular with two thin edges 102A-B and two broad edges 104A-B that are larger in width than the thin edges 102A-B. The thin edges 102A-B of the flat wire conductor 100A in FIG. 1A are rounded. For example, the flat wire conductor 100A may be manufactured by flattening a wire with a generally round cross-section, which creates two rounded thin edges 102A-B and two flat broad edges 104A-B.

FIG. 1B is a cross-section view of a second example configuration of a flat wire conductor 100B that may be used in the present systems and methods. Similar to the flat wire conductor 100A in FIG. 1A, the cross section of the flat wire conductor 100B may be rectangular with two thin edges 102C-D and two broad edges 104A-B that are larger in width than the thin edges 102C-D. However, unlike FIG. 1A, the thin edges 102C-D of the flat wire conductor 100B in FIG. 1B are flat or substantially flat. For example, the flat wire conductor 100B may be manufactured with a rectangular profile from the beginning instead of flattening a generally round wire as described above. Thus, the flat wire conductor 100B may also be referred to as a “rectangular wire conductor”. As used herein, the term “flat wire conductor” is used herein, may refer to a flat wire conductor 100A with rounded thin edges 102A-B (as in FIG. 1A) or a rectangular wire conductor 100B with flat thin edges 102C-D (as in FIG. 1B).

The present systems and methods are not limited to any particular shape or method of producing a flat conductor, i.e., a flat conductor with rounded thin edges 102A-B or non-rounded thin edges 102C-D may be used with the present systems and methods.

Furthermore, and without limitation, the flat wire conductors 100A-B used with the present systems and methods may be of any suitable dimensions (including length) and may be made from any suitable material, e.g., gold, copper, silver, aluminum, nickel, tin, zinc, and/or any other metals. The corners of the flat wire conductor 100A-B (i.e., each of the four transition points on the cross section of the flat wire conductor 100A-B between a thin edge 102A-B and a broad edge 104A-B) may be rounded, squared, or substantially squared.

Conventionally, most coils use round wires that can be sent away to a wire insulation coating house to apply a coating to a round wire. However, sending a flat wire away to a wire insulation coating house is typically not available due to industrial challenges, e.g., tearing the insulation up at the corner of the spring or edge-wound coil. Furthermore, the flat wire is bent on the thin edge 102A-D, so the thin edge 102A-D is stretched and the large faces of the broad edges 104A-B are stacked on top of each other. This type of coil may be referred to as “edge-wound” where the large faces of the broad edges 104A-B of the conductor are stacked upon each other. So that wire needs to be insulated from itself (from adjacent layers) and from whatever part of the electromechanical device the coil is going to be touching. Since there’s no organic coating that will withstand higher operating temperatures (e.g., 400 degrees Celsius or above), the present systems and methods describe how a high temperature coating can be applied to a flat wire conductor.

Specifically, as described in more detail below, a flat wire conductor 100A-B may be (1) shaped into a spring (in which adjacent layers of the flat wire conductor 100B to not touch each other) by bending the thin edges 102A-D; (2) coated with high-temperature insulation material (not shown in FIGS. 1A-1B) using a first heat treatment that bonds the insulation material to the flat wire conductor 100A-B; and (3) compressed into a coil (in which insulation coating adjacent layers of the flat wire conductor 100A-B is bonded to each other) using a second heat treatment. The coating of the spring and the compression into a coil may be performed as part of the same process or separate processes.

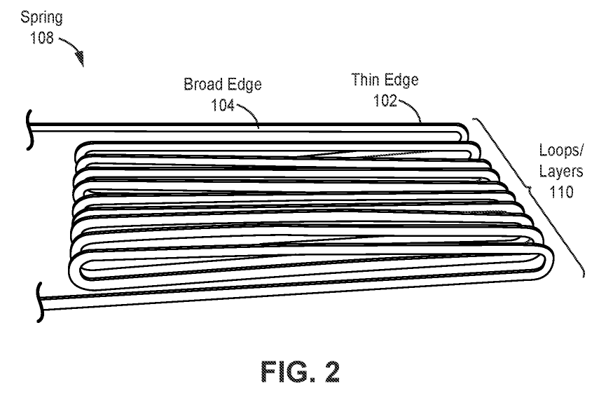

FIG. 2 is a perspective view of a flat wire conductor 100A-B formed into a spring 108 that may be used in the present systems and methods. As before, the flat wire conductor 100A-B may have a substantially rectangular cross section (with flat or rounded thin edges 102A-D) at any given point with two thin edges 102A-D and two broad edges 104A-B. The flat wire conductor 100A-B may be bent on the thin edges 102A-D and wound into the shape of the spring 108 that includes multiple loops or layers 110. When the flat wire conductor 100A-B is bent on the thin edges 102A-D, the broad edges 104A-B in most of the loops or layers 110 (except for the top and bottom loops or layers 110) face a broad edges 104A-B of an adjacent loop or layer 110 without physically contacting the adjacent loop(s) or layer(s) 110. The spring 108 may include any number of loops or layers 110 (although 10 loops or layers 110 are shown in FIG. 2). At this stage, the shape is that of the spring 108 may be somewhat flexible depending on the material used for the conductor and have some spacing between adjacent layers.

The spring 108 may be coated with one or more layers of high-temperature insulation (HTI) to bond the insulation to the flat wire conductor 100A-B. This coating (or coatings) may include a first heat treatment that removes organic material from the ingredients (e.g., a glass powder in the form of a slurry or paste) that cannot withstand temperatures above a first temperature. The HTI ingredients may include organic and inorganic ingredients (such as (1) an organic binder like polyester and/or polyamide and/or (2) a mix of different metal oxides), where the material that burns off during the first heat treatment is organic material (and optionally some inorganic material) to produce glass insulation.

Conventionally insulation coating is applied to round wires before shaping. However, with flat wire conductors 100A-B the coating is applied during and/or after the spring 108 is shaped since the end turns of each loop or layer 110 occur by bending/stretching the thin edges 102 into a 180 degree turn, which would rip apart the insulation if conventional pre-applied organic coatings were used.

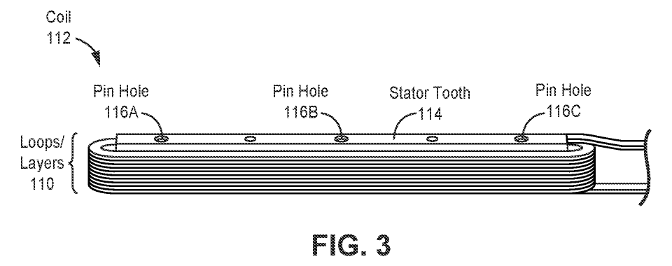

FIG. 3 is a perspective view of a coil 112 that may be formed from a spring 108 in the present systems and methods. The coil may be formed by compressing the loops or layers 110 of the spring 108 so that the insulation coating of adjacent loops or layers 110 is in contact with each other, e.g., there may not be any space between adjacent loops or layers 110 in the final coil 112 like there were in the spring 108. For example, the coil 112 in FIG. 3 may be formed from the spring 108 of FIG. 2. This compression may include a second heat treatment (or “bonding”) that bonds the insulation coating on adjacent loops or layers 110 to each other (in contrast to the first heat treatment that only coats the spring, i.e., bonds the insulation to the flat wire conductor 100A-B). Thus, the coil 112 may be also be referred to as a “bonded coil” following the second heat treatment. Optionally, the first and second heat treatment may be consolidated into a single substantially continuous process. Alternatively, the first and second heat treatment may be performed as distinct processes with some non-negligible length of time in between.

After the second heat treatment, the coil 112 may be rigid, e.g., due to (1) compression of the loops or layers 110 together; and (2) the bonding of the insulation coating on adjacent loops or layers 110 to each other.

In addition to bonding the insulation coating on adjacent loops or layers 110 to each other, the second heat treatment imparts high-temperature capabilities to the coil 112. Specifically, the second heat treatment assures the bonded coil 112 has high temperature (e.g., above 400 degrees Celsius) capabilities without atmospheric protection, e.g., the coil 112 is not required to be hermetically sealed and/or surrounded by inert gas to operate at high temperatures.

In other words, the bonded coil 112 may be able to withstand temperatures up to (or substantially near) the melting point of the insulation without degradation following the second heat treatment. Burning off the organic material during the second heat treatment may protect the conductor against oxidation at high temperature. For example, and without limitation, the melting point of the insulation may be 500-600 degrees Celsius (which is likely beyond the operating temperature for the coil 112), while the final bonded coil 112 may be able to operate from around -40 degrees Celsius up to the melting point of the insulation following the second heat treatment.

Optionally, new layer(s) of insulation can also be applied during the second (high-temperature) heat treatment. The spray coating/firing can include multiple layers of insulator applied to reach a desired thickness.

Conventionally, the shape of the coil 112 is formed in a winding process, while the coil 112 of the present systems and methods is formed into its final shape using a high-temperature thermal process (second heat treatment) in which the adjacent layers of insulation are bonded to each other.

In some configurations, the coil 112 that may be formed around a stator tooth 114. The stator tooth 114 may be a generally rectangular metallic object in the center of the coil 112. The stator tooth 114 may be magnetized via the conductor 100 and will provide the electromagnetic force to turn a rotor, which provides mechanical work. In a motor, multiple stator teeth 114 may be arranged in a specific pattern to create a magnetic field that interacts with the rotating armature. The stator teeth may be made of a ferromagnetic material, such as iron or steel, and may be designed to withstand the high temperatures and magnetic forces generated during operation. During operation, the coil 112 may remain wrapped around the stator tooth 114 or the stator tooth 114 may be removed from the center of the coil 112.

In some configurations, one or more pins (not shown) may be inserted through pin hole(s) 116A-C in the stator tooth 114 to provide a load during bonding (e.g., during the second heat treatment), then removed before operation. The bonded coil 112 may or may not remain wrapped around the stator tooth during operation. Generally, and without limitation, the HTI does not bond to the stator tooth 114 or any pins that may be inserted through the stator tooth 114.

Additionally, the shape of the coil 112 may not be symmetric around any axis, e.g., one side of the coil may have an even number of edges, while the other side of the coil may have an odd number of edges), which might make conventional insulation coating methods unsuitable for the coil 112 (and/or the spring 108), e.g., because asymmetry will effect the path that heat will dissipate, which can cause issues due to one side of the coil 112 being hotter than another side. It should be noted that the stator tooth may have symmetry even though the coil 112 does not.

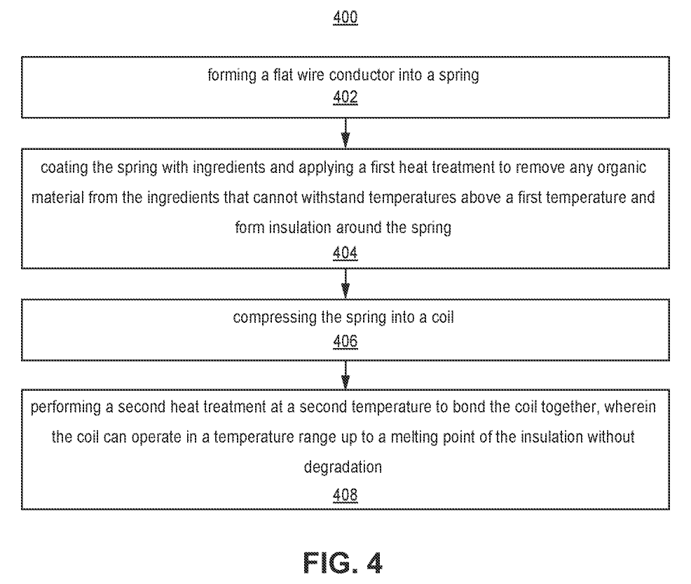

FIG. 4 is a flow diagram illustrating a method 400 for forming a coil 112, also referred to as a “bonded coil” or “insulated coil”. One or more of the steps in the method 400 may be combined in a single step even though they are described as separate steps below, e.g., multiple steps may be consolidated into a single substantially continuous process or performed as distinct processes with some non-negligible length of time in between. A cooling period following one or both heat treatments may be required before handling the flat wire conductor 100A-B.

In step 402, a flat wire conductor may be formed into a spring 108, e.g., as illustrated in FIG. 2. The flat wire conductor 100A-B may be made of any suitable dimensions (including length) and may be made from any suitable material, e.g., copper, silver, aluminum, nickel, tin, zinc, and/or any other metals. The cross section of the flat wire conductor 100A-B may be substantially rectangular with two broad edges 104A-B that are larger in width than two thin edges 102A-D, which are either rounded as in FIG. 1A or non-rounded as in FIG. 1B. The corners of the flat wire conductor 100A-B (i.e., each of the four transition points on the cross section of the flat wire conductor 100A-B between a thin edge 102A-B and a broad edge 104A-B) may be rounded, squared, or substantially squared.

The spring 108 may be formed by bending the thin edges 102A-D of the flat wire conductor 100A-B to wind it into the shape of the spring 108 with multiple loops or layers 110. When the flat wire conductor 100A-B may be bent on the thin edges 102A-D, the broad edges 104A-B in most of the loops or layers 110 (except for the top and bottom loops or layers 110) face a broad edges 104A-B of an adjacent loop or layer 110 without physically contacting the adjacent loops or layers 110. The spring 108 may include any number of loops or layers 110 and may be somewhat flexible and asymmetric around any axis.

In step 404, the spring 108 may be coated with ingredients and a first heat treatment may be applied to remove any organic material from the ingredients that cannot withstand temperatures above a first temperature and form insulation around the spring. One or more coatings may be to bond the insulation to the flat wire conductor 100A-B. This coating (or coatings) may include a first heat treatment that removes organic material from the ingredients (e.g., a glass powder in the form of a slurry or paste) that cannot withstand temperatures above a first temperature. The HTI ingredients may includes organic and inorganic ingredients, where the material that burns off during the first heat treatment is organic material (and optionally some inorganic material) to produce glass insulation.

coating the flat wire conductor 100A-B after the spring 108 has been shaped avoids damaging insulation that would otherwise occur when bending/stretching the thin edges 102 into a 180 degree if conventional pre-applied organic coatings were used.

In step 406, the spring 108 may be compressed into a coil 112, e.g., as illustrated in FIG. 3. The spring 108 may include some physical distance between broad edges 104 in adjacent loops or layers 110 of the spring 108. In contrast, broad edges 104 in adjacent loops or layers 110 of the spring 108 may be in physical contact with one another.

In step 408, a second heat treatment may be applied at a second temperature to bond the coil 112 together, wherein the coil can operate in a temperature range up to a melting point of the insulation without degradation. The second heat treatment may bond the insulation coating on adjacent loops or layers 110 to each other (whereas the first heat treatment bonds the insulation to the flat wire conductor 100A-B). After the second heat treatment, the coil 112 may be rigid. In some configurations, the compression in step 406 and the second heat treatment in step 408 are performed at the same time, overlapping periods of time or sequentially with a short period of time in between (e.g., second(s)), e.g., the spring 108 may be compressed into the coil 112 while it is being heated or shortly after heating.

In some configurations, the shape of the coil 112 may not be symmetric around any axis, e.g., one side of the coil may have an even number of edges, while the other side of the coil may have an odd number of edges.

As noted above, the second heat treatment may also impart high-temperature capabilities to the coil 112 by ensuring that the bonded coil 112 is able to withstand temperatures up to (or substantially near) the melting point of the insulation without degradation following the second heat treatment. For example, and without limitation, the melting point of the insulation may be 500-600 degrees Celsius (which is likely beyond the operating temperature for the coil 112), while the final bonded coil 112 may be able to operate from around -40 degrees Celsius up to the melting point of the insulation following the second heat treatment.

Optionally, new layer(s) of insulation can also be applied during the second (high-temperature) heat treatment. The spray coating/firing can include multiple layers of insulator applied to reach a desired thickness.

In some configurations, the coil 112 may be formed around a stator tooth 114. In some configurations, one or more pins may be inserted through pin hole(s) 116A-C in the stator tooth 114 to provide a load during bonding during the second heat treatment, then removed before operation. The bonded coil 112 may or may not remain wrapped around the stator tooth during operation. Generally, and without limitation, the HTI does not bond to the stator tooth 114 or any pins that may be inserted through the stator tooth 114.

### Terminology

Brief definitions of terms, abbreviations, and phrases used throughout this application are given below.

The term “determining” may include calculating, computing, processing, deriving, investigating, looking up (e.g., looking up in a table, a database or another data structure), ascertaining and the like. Also, “determining” may also include receiving (e.g., receiving information), accessing (e.g., accessing data in a memory) and the like. Also, “determining” may include resolving, selecting, choosing, establishing and the like.

The phrase “based on” does not mean “based only on,” unless expressly specified otherwise. In other words, the phrase “based on” describes both “based only on” and “based at least on”. Additionally, the term “and/or” means “and” or “or”. For example, “A and/or B” can mean “A”, “B”, or “A and B”. Additionally, “A, B, and/or C” can mean “A alone,” “B alone,” “C alone,” “A and B,” “A and C,” “B and C” or “A, B, and C.”

The terms “connected”, “coupled”, and “communicatively coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in exemplary configurations”, “in example configurations”, “in some configurations”, “according to some configurations”, “in the configurations shown”, “in other configurations”, “configurations”, “in examples”, “examples”, “in some examples”, “some examples” and the like generally mean the particular feature, structure, or characteristic following the phrase is included in at least one configuration of the present disclosure, and may be included in more than one configuration of the present disclosure. In addition, such phrases do not necessarily refer to the same configurations or different configurations.

If the specification states a component or feature “may,” “can,” “could,” or “might” be included or have a characteristic, that particular component or feature is not required to be included or have the characteristic.

The terms “responsive” or “in response to” may indicate that an action is performed completely or partially in response to another action.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

In conclusion, the present disclosure provides novel systems, methods, and arrangements for high temperature electrical conductor insulation for electromechanical devices. While detailed descriptions of one or more configurations of the disclosure have been given above, various alternatives, modifications, and equivalents will be apparent to those skilled in the art without departing from its essential characteristics. For example, while the configurations described above refer to particular features, functions, procedures, components, elements, and/or structures, the scope of this disclosure also includes configurations having different combinations of features, functions, procedures, components, elements, and/or structures, and configurations that do not include all of the described features, functions, procedures, components, elements, and/or structures. Accordingly, the scope of the present disclosure is intended to embrace all such alternatives, modifications, and variations as fall within the scope of the claims, together with all equivalents thereof. Therefore, the above description should not be taken as limiting since the scope of the invention is indicated by the appended claims.

### Examples

Example 1 includes a method of forming a bonded coil, comprising: forming a flat wire conductor into a spring; coating the spring with ingredients and applying a first heat treatment to remove any organic material from the ingredients that cannot withstand temperatures above a first temperature and form insulation around the spring; compressing the spring into an edge-wound coil; performing a second heat treatment at a second temperature to bond the edge-wound coil together and form the bonded coil, wherein the edge-wound coil can operate in a temperature range up to a melting point of the insulation without degradation.

Example 2 includes the method of Example 1, wherein the first heat treatment and the second heat treatment are performed as separate processes.

Example 3 includes the method of any of Examples 1-2, wherein the first heat treatment and the second heat treatment are performed in a single process.

Example 4 includes the method of any of Examples 1-3, wherein the bonded coil operates in the temperature range up to the melting point of the insulation without being hermetically sealed from ambient air.

Example 5 includes the method of any of Examples 1-4, wherein the bonded coil operates in the temperature range up to the melting point of the insulation without being surrounded by inert gas.

Example 6 includes the method of any of Examples 1-5, wherein the first heat treatment removes at least some inorganic material in the ingredients.

Example 7 includes the method of any of Examples 1-6, wherein the first heat treatment bonds the ingredients to the flat wire conductor.

Example 8 includes the method of any of Examples 1-7, wherein the insulation is glass insulation.

Example 9 includes the method of any of Examples 1-8, wherein the melting point of the insulation is at least 500 degrees Celsius.

Example 10 includes the method of any of Examples 1-9, wherein the second heat treatment bonds the insulation coating each layer of the edge-wound coil to the insulation coating each adjacent layer of the edge-wound coil.

Example 11 includes a bonded coil, comprising: a flat wire conductor formed into a spring; ingredients that coat the spring, wherein a first heat treatment removes any organic material from the ingredients that cannot withstand temperatures above a first temperature and form insulation around the spring; wherein the spring is compressed into an edge-wound coil; wherein a second heat treatment at a second temperature bonds the edge-wound coil together and form the bonded coil; wherein the bonded coil can operate in a temperature range up to a melting point of the insulation without degradation.

Example 12 includes the bonded coil of Example 11, wherein the first heat treatment and the second heat treatment are performed as separate processes.

Example 13 includes the bonded coil of any of Examples 11-12, wherein the first heat treatment and the second heat treatment are performed in a single process.

Example 14 includes the bonded coil of any of Examples 11-13, wherein the bonded coil operates in the temperature range up to the melting point of the insulation without being hermetically sealed from ambient air.

Example 15 includes the bonded coil of any of Examples 11-14, wherein the bonded coil operates in the temperature range up to the melting point of the insulation without being surrounded by inert gas.

Example 16 includes the bonded coil of any of Examples 11-15, wherein the first heat treatment removes at least some inorganic material in the ingredients.

Example 17 includes the bonded coil of any of Examples 11-16, wherein the first heat treatment bonds the ingredients to the flat wire conductor.

Example 18 includes the bonded coil of any of Examples 11-17, wherein the insulation is glass insulation.

Example 19 includes the bonded coil of any of Examples 11-18, wherein the melting point of the insulation is at least 500 degrees Celsius.

Example 20 includes the bonded coil of any of Examples 11-19, wherein the second heat treatment bonds the insulation coating each layer of the edge-wound coil to the insulation coating each adjacent layer of the edge-wound coil.

What is claimed is:

1. A method of forming a bonded coil, comprising:
forming a flat wire conductor into a spring;
coating the spring with ingredients and applying a first heat treatment to remove any organic material from the ingredients that cannot withstand temperatures above a first temperature and form insulation around the spring;
compressing the spring into an edge-wound coil;
performing a second heat treatment at a second temperature to bond the edge-wound coil together and form the bonded coil, wherein the bonded coil can operate in a temperature range up to a melting point of the insulation without degradation.

2. The method of claim 1, wherein the first heat treatment and the second heat treatment are performed as separate processes.

3. The method of claim 1, wherein the first heat treatment and the second heat treatment are performed in a single process.

4. The method of claim 1, wherein the bonded coil operates in the temperature range up to the melting point of the insulation without being hermetically sealed from ambient air.

5. The method of claim 1, wherein the bonded coil operates in the temperature range up to the melting point of the insulation without being surrounded by inert gas.

6. The method of claim 1, wherein the first heat treatment removes at least some inorganic material in the ingredients.

7. The method of claim 1, wherein the first heat treatment bonds the ingredients to the flat wire conductor.

8. The method of claim 1, wherein the insulation is glass insulation.

9. The method of claim 1, wherein the melting point of the insulation is at least 500 degrees Celsius.

10. The method of claim 1, wherein the second heat treatment bonds the insulation coating each layer of the edge-wound coil to the insulation coating each adjacent layer of the edge-wound coil.

11. A bonded coil, comprising:
a flat wire conductor formed into a spring;
ingredients that coat the spring, wherein a first heat treatment removes any organic material from the ingredients that cannot withstand temperatures above a first temperature and form insulation around the spring;
wherein the spring is compressed into an edge-wound coil;
wherein a second heat treatment at a second temperature bonds the edge-wound coil together and form the bonded coil;
wherein the bonded coil can operate in a temperature range up to a melting point of the insulation without degradation.

12. The bonded coil of claim 11, wherein the first heat treatment and the second heat treatment are performed as separate processes.

13. The bonded coil of claim 11, wherein the first heat treatment and the second heat treatment are performed in a single process.

14. The bonded coil of claim 11, wherein the bonded coil operates in the temperature range up to the melting point of the insulation without being hermetically sealed from ambient air.

15. The bonded coil of claim 11, wherein the bonded coil operates in the temperature range up to the melting point of the insulation without being surrounded by inert gas.

16. The bonded coil of claim 11, wherein the first heat treatment removes at least some inorganic material in the ingredients.

17. The bonded coil of claim 11, wherein the first heat treatment bonds the ingredients to the flat wire conductor.

18. The bonded coil of claim 11, wherein the insulation is glass insulation.

19. The bonded coil of claim 11, wherein the melting point of the insulation is at least 500 degrees Celsius.

20. The bonded coil of claim 11, wherein the second heat treatment bonds the insulation coating each layer of the edge-wound coil to the insulation coating each adjacent layer of the edge-wound coil.
